(19) United States
(12) Patent Application Publication
(10) Pub. No.: US 2024/0365438 A1
(43) Pub. Date: Oct. 31, 2024

(54) THERMAL EMITTER MODULE AND THERMAL RADIATION LIGHT SOURCE

(71) Applicant: Tamron Co., Ltd., Saitama (JP)

(72) Inventor: Shunya FUKUI, Saitama (JP)

(73) Assignee: Tamron Co., Ltd., Saitama (JP)

(21) Appl. No.: 18/624,177

(22) Filed: Apr. 2, 2024

(30) Foreign Application Priority Data
Apr. 26, 2023 (JP) 2023-072705

(51) Int. Cl. H05B 3/00; H01K 1/18; H05B 3/08

(52) U.S. Cl. CPC H05B 3/009; H01K 1/18; H05B 3/08; H05B 2203/016; H05B 2203/032

(57) ABSTRACT

A thermal emitter module includes: a thermal emitter; a housing that houses the thermal emitter; and a support member interposed between the thermal emitter and the housing and supporting the thermal emitter, in which a constituent material of the support member contains at least one of an oxide or a nitride.

### CROSS-REFERENCE TO RELATED APPLICATIONS

This application is based on and claims the benefit of priority from Japanese Patent Application No. 2023-072705, filed on Apr. 26, 2023, the entire contents of which are incorporated herein by reference.

### BACKGROUND OF THE INVENTION

### Technical Field

The present invention relates to a thermal emitter module and a thermal radiation light source.

### Related Art

Every object is composed of molecules or atoms. The molecules or atoms move vigorously according to a temperature of the object. With this movement, the object emits an electromagnetic wave. The electromagnetic wave is called radiation or thermal radiation.

The thermal radiation is expressed by a radiant intensity of an ideal surface called blackbody radiation and a dimensionless number called emissivity. The blackbody radiation is a function of temperature as described by Planck's law. The emissivity is a constant determined by physical properties of a material, a surface state, and the like, and indicates a ratio of the radiant intensity between a real surface and a blackbody surface. That is, the radiant intensity on the real surface is obtained by multiplying the blackbody radiation by the emissivity.

It has long been known that the emissivity increases when the surface of the object is roughened or oxidized. Furthermore, in recent years, study on control of the emissivity using a fine structure called meta-surface has been actively conducted.

A halogen lamp or the like has been known as a light source utilizing the thermal radiation from long ago. In recent years, an infrared light emitting device specialized for infrared light is also known (see, for example, JP 2020-98757 A). Such an infrared light emitting device is also called a thermal emitter module.

As described above, the blackbody radiation is the basis of the thermal radiation, and the radiant intensity is expressed by a function of temperature. Therefore, in the thermal emitter module, the thermal radiation is obtained by heating a thermal emitter to a high temperature. In a case where it is desired to increase the radiant intensity or use light on a shorter wavelength side in the thermal emitter module, the temperature of the thermal emitter is set higher.

Incidentally, electricity is generally used as means for heating the thermal emitter. Electrons flowing through a conductor serve as carriers of both electricity (electric charge) and heat. Therefore, a material or structure that conducts electricity well also conducts heat easily.

As described above, the thermal emitter is heated to a high temperature during operation. Here, the heat of the thermal emitter is conducted from the thermal emitter to the thermal emitter module via a wiring for supplying power to the thermal emitter, a bonding member for bonding the thermal emitter to a housing of the thermal emitter module, or the like. As a result, not only the surface of the thermal emitter but also the surface of the thermal emitter module is likely to have a high temperature.

One aspect of the present invention has been made in view of the above-described problems, and an object of the present invention is to provide a thermal emitter module in which a surface of a housing is less likely to have a high temperature as compared with the thermal emitter module described in JP 2020-98757 A, and a thermal radiation light source including such a thermal emitter module.

### SUMMARY OF THE INVENTION

In order to solve the above problems, a thermal emitter module according to a first aspect of the present invention includes: a thermal emitter; a housing configured to house the thermal emitter; and a support member interposed between the thermal emitter and the housing and configured to support the thermal emitter. In the thermal emitter module, a constituent material of the support member contains at least one of an oxide or a nitride.

According to the above configuration, the support member is interposed between the thermal emitter and the housing. Therefore, a length of a heat conduction path between the thermal emitter and the housing can be designed to be longer as compared with a case where the thermal emitter is directly fixed to the housing.

The constituent material contains at least one of an oxide or a nitride. Therefore, a thermal conductivity of the support member configured as described above is lower than a thermal conductivity of metal, and thus, heat conduction from the thermal emitter to the housing can be suppressed.

As described above, the thermal emitter module can suppress thermal energy that can be conducted from the thermal emitter to the housing, as compared with the thermal emitter module described in JP 2020-98757 A. Therefore, in the thermal emitter module, the surface of the housing is less likely to have a high temperature.

The thermal emitter module according to a second aspect of the present invention adopts, in addition to the configuration of the thermal emitter module according to the first aspect described above, a configuration in which the housing has a cavity that houses the thermal emitter and the support member, the support member has a first region that is provided in a region including a center of gravity and in which the thermal emitter is installed, and a second region that is provided in a region separated from the first region and in which the support member is fixed to the housing, and a region of the support member including the first region other than the second region is separated from an inner wall of the cavity.

According to the above configuration, the first region and the second region are separated from each other, and a region of the support member including the first region other than the second region is separated from the inner wall of the cavity. Therefore, the thermal emitter module can reliably lower the temperature of the surface of the housing as compared with the thermal emitter module described in JP 2020-98757 A.

The thermal emitter module according to a third aspect of the present invention adopts, in addition to the configuration of the thermal emitter module according to the second aspect described above, a configuration in which the support member further has a third region interposed between the first region and the second region, and a width of the third region is smaller than a width of the thermal emitter in at least a part of an entire section extending between the first region and the second region.

According to the above configuration, a cross-sectional area in which heat can be conducted in the third region can be limited. Therefore, the thermal emitter module can more reliably lower the temperature of the surface of the housing as compared with the thermal emitter module described in JP 2020-98757 A.

The thermal emitter module according to a fourth aspect of the present invention adopts, in addition to the configuration of the thermal emitter module according to the third aspect described above, a configuration in which the support member is a plate-like member in which the first region, the second region, and the third region extend along one plane.

According to the above configuration, the support member can be easily manufactured by two-dimensionally patterning a substrate made of the constituent material as a starting material. Therefore, the thermal emitter module can reduce the manufacturing cost in mass production.

The thermal emitter module according to a fifth aspect of the present invention adopts, in addition to the configuration of the thermal emitter module according to the fourth aspect described above, a configuration in which the support member has a pair of principal surfaces facing each other, the first region is provided on one principal surface of the support member, a pair of power supply patterns extending from the second region to the first region via the third region is provided on the one principal surface, the pair of power supply patterns being made of metal films, and each of the pair of power supply patterns is electrically connected to each of a pair of electrode patterns included in the thermal emitter in the first region.

According to the above configuration, the power supply patterns can be formed on one principal surface of the support member in a pre-process or post-process of the process of two-dimensionally patterning the support member that is a plate-like member. A photolithography technique can be used in the process of forming the power supply pattern. Therefore, the thermal emitter module can further reduce the manufacturing cost in mass production as compared with a case where the first region and the second region or the electrode pattern of the thermal emitter and the second region are electrically connected by a conductive wire.

The thermal emitter module according to a sixth aspect of the present invention adopts, in addition to the configuration of the thermal emitter module according to the fifth aspect described above, a configuration in which

$$2 \times {R}_{2} < {R}_{1} < 10000 \times {R}_{2} \qquad ( 1 )$$

$$2 \times {R}_{2} < {R}_{1 H} < 10000 \times {R}_{2} \qquad ( 2 )$$

where
R₁ (Ω) and R_{1H} (Ω) are resistance values between the pair of electrode patterns at 25° C. and 500° C., and
R₂ (Ω) is a resistance value of each of the pair of power supply patterns at 25° C.

Each of the pair of power supply patterns made of metal films has a function of conducting drive power from the housing to the thermal emitter and a function of conducting heat from the thermal emitter to the housing. In the metal, electrons serve as carriers of electricity and heat.

The thermal emitter module generates thermal radiation by converting the drive power supplied by the thermal emitter into Joule heat and maintaining the temperature of the thermal emitter at a high temperature (for example, 500° C. or 800° C.). In order to suppress generation of unnecessary Joule heat in each of the pair of power supply patterns, the resistance R₂ is preferably smaller than the resistance R₁. However, when the resistance R₂ is excessively smaller than the resistance R₁, heat generation in each of the pair of power supply patterns can be suppressed, but a thermal conductivity between the thermal emitter and the housing becomes excessively high. As a result, a heat insulating property between the thermal emitter and the housing is lowered, and the temperature of the surface of the housing is likely to increase.

In view of the above points, the resistance R₁, the resistance R_{1H}, and the resistance R₂ preferably satisfy the above Expressions (1) and (2).

The thermal emitter module according to a seventh aspect of the present invention adopts, in addition to the configuration of the thermal emitter module according to the fifth aspect or the sixth aspect described above, a configuration in which the pair of power supply patterns is any of gold, silver, and an alloy containing silver as a main component.

As described above, the support member is interposed between the thermal emitter and the housing, and the pair of power supply patterns is provided on the one principal surface of the support member, whereby the pair of power supply patterns can be supported using the support member. As a result, these metals or alloy having a melting point of about 1000° C. can be used as a material of the pair of power supply patterns. The alloy containing silver as a main component also includes an alloy obtained by sintering a silver paste.

The thermal emitter module according to an eighth aspect of the present invention adopts, in addition to the configuration of the thermal emitter module according to any one of the first to seventh aspects described above, a configuration in which a thermal conductivity of the constituent material is 0.1 W/m·° C. or more and 30 W/m·° C. or less.

The thermal conductivity of the constituent material is, for example, 0.1 W/m·° C. or more and 30 W/m·° C. or less. The amount of heat conduction can be reliably reduced by using a material having a low thermal conductivity included in this range as the constituent

The thermal emitter module according to a ninth aspect of the present invention adopts, in addition to the configuration of the thermal emitter module according to any one of the first to eighth aspects described above, a configuration in which the constituent material of the support member is a ceramic material, and the cavity has an internal pressure lower than an atmospheric pressure and is sealed.

A ceramic material having a high melting point is suitable as the constituent material. The ceramic material has, in addition to a high melting point, a high flexural strength even at a high temperature (for example, 500° C. or 800° C.), and exhibits low outgassing even at a high temperature. Therefore, according to the above configuration, even when the thermal emitter module is operated at a high temperature, it is possible to suppress an increase in internal pressure of the cavity, and thus, it is possible to suppress an increase in temperature of the surface of the housing. In addition, the amount of heat transfer via gas can be suppressed by decreasing the internal pressure of the cavity.

The thermal emitter module according to a tenth aspect of the present invention adopts, in addition to the configuration of the thermal emitter module according to the ninth aspect described above, a configuration in which the ceramic material is a mixture of calcium silicate and lithium aluminosilicate.

An example of such a ceramic material is Adceram-CS (registered trademark). Adceram-CS (registered trademark) is suitable in terms of physical properties such as a low thermal conductivity, a low linear expansion coefficient, and a mechanical strength at a high temperature.

In order to solve the above problems, a thermal radiation light source according to an eleventh aspect of the present invention includes the thermal emitter module according to any one of the first to tenth aspects described above.

The thermal radiation light source according to one aspect of the present invention has the same effect as that of the thermal emitter module according to one aspect of the present invention.

According to one aspect of the present invention, it is possible to provide the thermal emitter module in which the surface of the housing is less likely to have a high temperature as compared with the thermal emitter module described in JP 2020-98757 A, and the thermal radiation light source including such a thermal emitter module.

### BRIEF DESCRIPTION OF THE DRAWINGS

FIG. 1A is a plan view of a thermal emitter module according to an embodiment of the present invention; FIG. 1B is a cross-sectional view of the thermal emitter module illustrated in FIG. 1A;

FIG. 2A is a plan view of a support member included in the thermal emitter module illustrated in FIGS. 1A and 1B; FIGS. 2B to 2E are plan views of first to fourth modifications of the support member illustrated in FIG. 2A; and

FIG. 3 is a cross-sectional view of a thermal emitter included in the thermal emitter module illustrated in FIGS. 1A and 1B.

### DESCRIPTION OF THE EMBODIMENTS

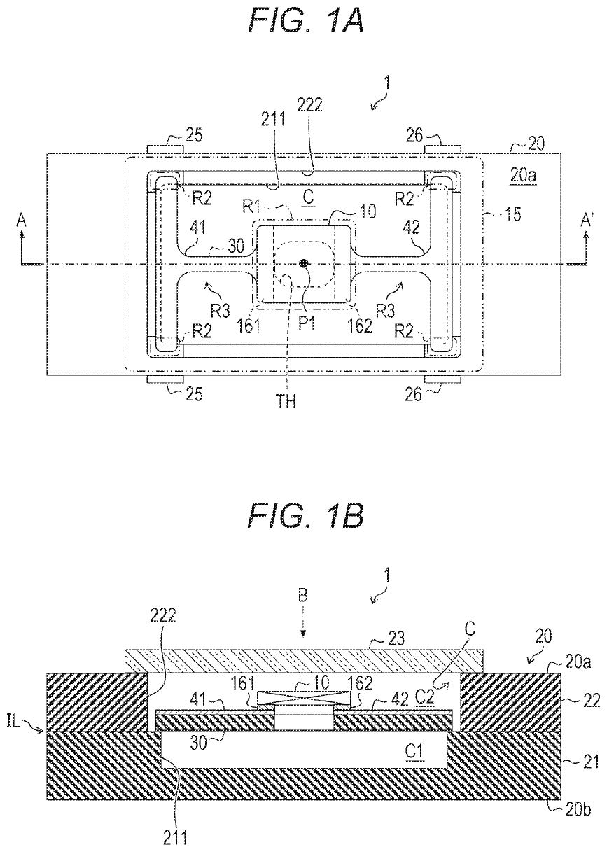

A thermal emitter module 1 according to an embodiment of the present invention will be described with reference to FIGS. 1A to 3.

FIG. 1A is a plan view of the thermal emitter module 1. FIG. 1B is a cross-sectional view of the thermal emitter module 1. The plan view illustrated in FIG. 1A is obtained by viewing a principal surface of an optical window 23 included in the thermal emitter module 1 in plan view from a direction of a normal to the principal surface (a direction of an arrow B illustrated in FIG. 1B). The cross-sectional view illustrated FIG. 1B is obtained by viewing a cross section (hereinafter, referred to as an A-A′ cross section) including a line A-A′ illustrated in FIG. 1A and the normal to the principal surface of the optical window 23 from a direction of an arrow illustrated in FIG. 1A.

In the following, the term “plan view” means a drawing obtained by viewing each member from the direction of the arrow B illustrated in FIG. 1B, and the term “cross-sectional view” means a drawing obtained by viewing the A-A′ cross section from the direction of the arrow illustrated in FIG. 1A. In addition, the expression “in plan view” means that the principal surface of each member is viewed from the direction of the arrow B illustrated in FIG. 1B.

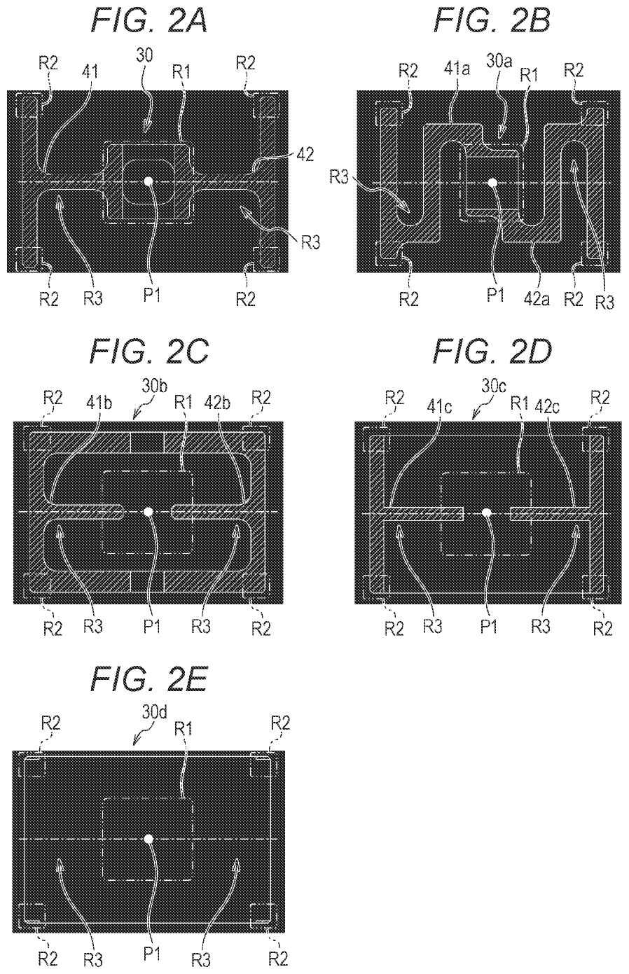

FIG. 2A is a plan view of a support member 30 included in the thermal emitter module 1. FIGS. 2B to 2E are plan views of support members 30a to 30d which are first to fourth modifications of the support member 30 illustrated in FIG. 2A. The plan views illustrated in FIGS. 2A to 2E are obtained by viewing principal surfaces of the support members 30, and 30a to 30d in plan view from the direction of the normal to the principal surfaces (the direction of the arrow B illustrated in FIG. 1B).

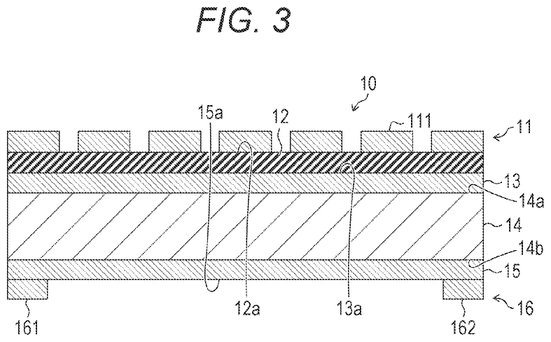

FIG. 3 is a cross-sectional view of the thermal emitter module 1.

### Configuration of Thermal Emitter Module

As illustrated in FIGS. 1A and 1B, the thermal emitter module 1 includes a thermal emitter 10, a housing 20, the support member 30, and power supply patterns 41 and 42.

The thermal emitter module 1 emits an electromagnetic wave (specifically, at least one of visible light, near-infrared light, mid-infrared light, or far-infrared light) caused by thermal radiation by energizing a conductor layer 13, a substrate 14, and a conductor layer 15 constituting a part of a metal-insulator-metal (MIM) structure (to be described later in detail with reference to FIG. 3) functioning as a plasmonic perfect absorber by using power terminals 25 and 26. As described above, the thermal emitter module 1 functions as a thermal radiation light source that emits an electromagnetic wave of at least one of visible light, near-infrared light, mid-infrared light, or far-infrared light. That is, a thermal radiation light source using the thermal emitter module 1 is also included in the scope of the present invention. The thermal radiation light source may further include a power supply module that supplies drive power to the thermal emitter module 1 via the power terminals 25 and 26, in addition to the thermal emitter module 1.

### <Support Member>

The support member 30 is interposed between the thermal emitter 10 and the housing 20, and is configured to support the thermal emitter 10. A constituent material of the support member 30 contains at least one of an oxide or a nitride. In addition, the constituent material is preferably any of an oxide, a nitride, a mixture containing an oxide as a main component, and a mixture containing a nitride as a main component. The constituent material includes, in addition to an oxide or a nitride, (1) a mixture of an oxide and a nitride, (2) a mixture of an oxide, a nitride, and other substances, (3) a mixture of an oxide and a substance other than a nitride, and (4) a mixture of a nitride and a substance other than an oxide. In the present invention, the main component refers to a component whose proportion in the whole mixture exceeds 50 wt %. In the present embodiment, Adceram-CS is used as the constituent material of the support member 30 as described later.

A thermal conductivity of the constituent material is preferably lower than a thermal conductivity of tungsten (198 W/m·° C.), and more preferably lower than a thermal conductivity of molybdenum (147 W/m·° C.). Tungsten and molybdenum are known as metals having a high melting point (that is, metals having a high heat resistance temperature). With the above configuration, it is possible to suppress thermal energy that can be conducted from the thermal emitter 10 to the housing 20 as compared with a case where the support member 30 is configured using a metal having a high dielectric permittivity such as tungsten or molybdenum as the constituent material.

In addition, the thermal conductivity of the constituent material is preferably 0.1 W/m·° C. or more and 30 W/m·° C. or less. The amount of heat conduction can be reliably reduced by using a material having a low thermal conductivity included in this range as the constituent material.

The constituent material preferably has a flexural strength of 40 MPa or more at 1000° C. Therefore, the constituent material is preferably a ceramic material. However, the constituent material is not limited to the ceramic material, and may be, for example, a glass material. Among the glass materials, quartz glass having a high melting point is preferable as the material of the support member 30.

In addition, the ceramic material is preferably a mixture of calcium silicate and lithium aluminosilicate. Examples of such a ceramic material include Adceram-CS. Specific examples of the product include Adceram-CS (registered trademark). In the present embodiment, the support member 30 is obtained by two-dimensionally patterning a shape of a substrate of Adceram-CS (registered trademark) as a starting material in plan view into the shape illustrated in FIGS. 1A and 2A.

As illustrated in FIGS. 1A and 2A, the support member 30 is obtained by enlarging a width of a region R1 including a center Pl of gravity based on an “H”-letter shape. The region R1 is an example of a first region, and is a region where the thermal emitter 10 is installed. As described above, the region R1 is provided in such a way as to include the center Pl of gravity of the support member 30. Hereinafter, the “H”-letter shape is also referred to as an H shape.

The shape of the support member 30 is designed in such a way that regions R2 positioned at four corners of the H shape are fixed to the housing 20 described later in plan view. The region R2 is an example of a second region. As is clear from FIGS. 1A and 2A, the region R2 is provided in a region separated from the region R1.

In the support member 30, a region interposed between the region R1 and the region R2 is hereinafter referred to as a region R3. The region R3 is an example of a third region, and is a strip-like region connecting the region R1 and the region R2 in the present embodiment.

In the support member 30, a region including the region R1 other than the region R2 is separated from an inner wall of a cavity C to be described later (FIGS. 1A and 1B). More specifically, in the present embodiment, the region R1 is separated from the inner wall of the cavity C, the region R2 is in contact with the inner wall of the cavity C, the region R3 is partially in contact with the inner wall of the cavity C, and the remaining portion is separated from the inner wall of the cavity C.

In one aspect of the present invention, a width of the region R3 is preferably smaller than a width of the thermal emitter 10 in a part of the entire section extending between the region R1 and the region R2. In the present embodiment, a configuration is adopted in which the width of the region R3 is smaller than the width of the thermal emitter 10 in the entire section extending between the region R1 and the region R2 (FIG. 1A and FIG. 2A).

In the present embodiment, the support member 30 is manufactured by two-dimensionally patterning one substrate made of Adceram-CS (registered trademark). Therefore, the support member 30 is a plate-shaped member in which the region R1, the region R2, and the region R3 extend along one plane.

The support member 30 has a pair of principal surfaces facing each other (see FIG. 1B). The thermal emitter 10 is fixed to one of the pair of principal surfaces of the support member 30 (the principal surface positioned on the upper side in FIG. 1B). That is, the region R1 is provided on one principal surface of the support member 30. In addition, the power supply patterns 41 and 42 extending from the region R2 to the region R1 via the region R3 are provided on one principal surface of the support member 30. The power supply patterns 41 and 42 are an example of a pair of power supply patterns. Each of the power supply patterns 41 and 42 is electrically connected to each of a pair of electrode patterns (electrodes 161 and 162) included in the thermal emitter 10 described later.

In the present embodiment, a sintered silver paste is used for each of the power supply patterns 41 and 42 as fixing means that fixes the electrodes 161 and 162 in an electrically connected state. However, the fixing means can be appropriately selected as long as it can withstand an operating temperature of the thermal emitter 10.

The power supply patterns 41 and 42 are preferably made of a metal film in order to reduce an electric resistance. The power supply patterns 41 and 42 are more preferably made of any of gold, silver, and an alloy containing silver as a main component. In addition, the power supply patterns 41 and 42 may have a stacked structure including a base layer and a conductive layer. In this case, examples of the base layer include a bilayer film of titanium/platinum. Examples of the conductive layer include a single-layer film of gold.

Design parameters in the power supply patterns 41 and 42 can be appropriately selected according to a desired resistance value in each of the power supply patterns 41 and 42. Examples of the design parameters in the power supply patterns 41 and 42 include a material of the power supply patterns 41 and 42, a shape of the power supply patterns 41 and 42 in plan view, and a thickness of the power supply patterns 41 and 42.

In addition, it is preferable that the following conditional expression is satisfied between the desired resistance value in each of the power supply patterns 41 and 42 and a resistance value of the thermal emitter 10 to be described later, that is, a resistance value between the pair of electrode patterns (electrodes 161 and 162) included in the thermal emitter 10.

The resistance values (the resistance values between the electrode 161 and the electrode 162) between the pair of electrode patterns of the thermal emitter 10 at 25° C. and 500° C. are defined as R₁ (Ω) and R_{1H} (Ω), and the resistance value of each of the power supply patterns 41 and 42 at 25° C. is defined as R₂ (Ω). In addition, it is preferable that the resistances R₁, R_{1H}, and R₂ satisfy the following Expressions (1) and (2).

$$2 \times {R}_{2} < {R}_{1} < 10000 \times {R}_{2} \qquad ( 1 )$$

$$2 \times {R}_{2} < {R}_{1 H} < 10000 \times {R}_{2} \qquad ( 2 )$$

A detailed configuration of the thermal emitter 10 will be described later with reference to FIGS. 2A to 2E.

### (Modifications of Support Member)

The support members 30a to 30d as first to fourth modifications of the support member 30 will be described with reference to FIGS. 2B to 2E. FIGS. 2B to 2E are plan views of the support members 30a to 30d, respectively. In one aspect of the present invention, the thermal emitter 10 may include any one of the support members 30a to 30d instead of the support member 30.

In the following, the support members 30a to 30d are compared with the support member 30, and differences of the support members 30a to 30d will be described. In the support member 30a illustrated in FIG. 2B, a region where power supply patterns 41a and 42a are provided in plan view is indicated by hatching with oblique lines. The same applies to the support members 30b and 30c illustrated in FIGS. 2C and 2D. The support member 30d illustrated in FIG. 2E adopts a configuration in which a region R1 and a region R2 are electrically connected using a pair of gold wires instead of the pair of power supply patterns. Therefore, only a small conductor pattern is provided in the region R2 in the support member 30d.

In the support member 30a (see FIG. 2B) as the first modification, a shape of a region R3 interposed between the region R1 and the region R2 is different from that of the support member 30. In the support member 30a, a path of the region R3 has a meandering shape, a length of the path of the region R3 is larger than that of the support member 30. Therefore, a difference between a temperature in the region R1 and a temperature in the region R2 can be increased, so that the heat conducted from the thermal emitter 10 to the housing 20 can be suppressed.

The support member 30b (see FIG. 2C) as the second modification is different from the support member 30 in that a pair of regions R3 is separated in a region R1. In the support member 30, an annular plate-shaped member is left in a rectangular portion corresponding to the region R1. On the other hand, in the support member 30b, a strip-like portion for supporting the thermal emitter 10 slightly protrudes at a rectangular portion corresponding to the region R1.

The support member 30c (see FIG. 2D) as the third modification is different from the support member 30 in that a shape in plan view is rectangular. A shape of power supply patterns 41c and 42c in plan view is an H-shape similarly to the support member 30.

The support member 30d (see FIG. 2E) as the fourth modification is different from the support member 30 in that a shape in plan view is rectangular and that power supply patterns 41 and 42 extending from a region R2 to a region R1 through a region R3 are not provided. In one aspect of the present invention, as described above, a metal wire can be used instead of the pair of power supply patterns.

### <Housing>

As illustrated in FIGS. 1A and 1B, the housing 20 is a rectangular parallelepiped block. In the present embodiment, the housing 20 includes a bottom plate 21 that supports the support member 30 to be described later, a frame body 22 that surrounds a side of the support member 30, the optical window 23 that seals the cavity C to be described later together with the bottom plate 21 and the frame body 22, and the power terminals 25 and 26.

A material of the bottom plate 21 and the frame body 22 is alumina, which is an example of ceramic. However, the ceramic forming the bottom plate 21 and the frame body 22 is not limited to alumina, and can be appropriately selected. Further, the material of the bottom plate 21 and the frame body 22 is not limited to ceramic, and may be a metal or alloy, or an organic compound such as a resin. However, in a case where the operating temperature of the thermal emitter 10 is set to 150° C. or higher, the material of the bottom plate 21 and the frame body 22 is preferably any of a metal, an alloy, and ceramic.

Among a pair of principal surfaces of the housing 20, the principal surface positioned on the upper side in the state illustrated in FIG. 1B is referred to as a principal surface 20a, and the principal surface positioned on the lower side in the state illustrated in FIG. 1B is referred to as a principal surface 20b. In the housing 20, the cavity C having an opening in the principal surface 20a and recessed in a direction from the principal surface 20a toward the principal surface 20b is formed. A depth of the cavity C is smaller than a thickness of the housing 20. Therefore, the cavity C does not penetrate through the principal surface 20b.

In the present embodiment, a main block portion of the housing 20 is formed by the bottom plate 21 and the frame body 22. Therefore, a recess 211 is formed in the bottom plate 21, and a through-hole 222 is formed in the frame body 22. An internal space of the recess 211 is referred to as a sub-cavity C1, and an internal space of the through-hole 222 is referred to as a sub-cavity C2. The recess 211 is a non-through-hole having an opening in one of a pair of principal surfaces of the bottom plate 21 that is opposite to the principal surface 20b and recessed in a direction from the principal surface adjacent to an intermediate layer IL toward the principal surface 20b. The through-hole 222 is a through-hole having an opening in each of a pair of principal surfaces of the frame body 22.

As illustrated in FIG. 1B, in a case where the bottom plate 21 and the frame body 22 overlap each other, the sub-cavity C1 and the sub-cavity C2 communicate with each other to form the cavity C. Further, a layer formed at an interface between the bottom plate 21 and the frame body 22 is referred to as the intermediate layer IL.

When the principal surface 20a is viewed in plan view, the recess 211 has a shape that includes most of the support member 30 but does not include a part of the support member 30 (see FIG. 1A). Therefore, when the support member 30 on which the thermal emitter 10 is fixed to the region R1 is placed on the sub-cavity C1, the support member 30 does not fall into the sub-cavity C1 because the region R2 and a part of the region R3 are supported by one principal surface of the bottom plate 21 (see FIG. 1B).

When the principal surface 20a is viewed in plan view, the through-hole 222 has a shape including the entire support member 30. As is clear from FIGS. 1A and 1B, an outer edge of the support member 30 is separated from the inner wall forming the through-hole 222 in the frame body 22.

The cavity C of the housing 20 configured as described above houses the thermal emitter 10 and the support member 30.

The through-hole 222 of the frame body 22, which is the opening of the cavity C, is sealed by the optical window 23. The cavity C is sealed by bonding the optical window 23 to the principal surface 20a of the housing 20 in such a way as to cover the through-hole 222. A technique for bonding the optical window 23 to the principal surface 20a can be appropriately selected.

The cavity C is preferably sealed in a state where an internal pressure is lower than an atmospheric pressure. The heat conducted from the thermal emitter 10 to the housing 20 via gas present in the cavity C can be more effectively suppressed with a lower internal pressure of the cavity C. That is, a heat insulating property of the cavity C can be enhanced. This configuration can be implemented, for example, by sealing the cavity C under a reduced pressure environment in which the pressure is lower than the atmospheric pressure. The internal pressure of the cavity C is not limited, but is preferably 1×10³ Pa or less, and more preferably 1×10¹ Pa or less.

The power terminals 25 and 26 are provided in regions corresponding to the regions R2 of the support member 30 at the intermediate layer IL interposed between the bottom plate 21 and the frame body 22 (see FIG. 1A). Each of the power terminals 25 and 26 is led out from the inside of the cavity C to the outside of the housing 20.

The power supply pattern 41 formed on the support member 30 is fixed to the power terminal 25 in such a way as to be electrically connected to the power terminal 25 in the region R2. Similarly, the power supply pattern 42 is fixed to the power terminal 26 in such a way as to be electrically connected to the power terminal 26 in the region R2. In the present embodiment, a sintered silver paste is used as fixing means that fixes the support member 30 and the power supply patterns 41 and 42 to each of the power terminals 25 and 26. However, the fixing means can be appropriately selected as long as it can withstand a predetermined temperature.

For example, in the thermal radiation light source including the thermal emitter module 1, the thermal emitter 10 can be driven by supplying the drive power supplied from the power supply module to the power terminals 25 and 26.

### <Thermal Emitter >

The thermal emitter 10 including the MIM structure will be described as a specific example of the thermal emitter included in the thermal emitter module 1. However, the thermal emitter included in the thermal emitter module 1 is not limited to the thermal emitter 10, and can be appropriately selected from existing thermal emitter s. The thermal emitter may be, for example, a carbon film formed on a substrate, or may be a silicon substrate whose surface is roughened.

The thermal emitter 10 includes the MIM structure including a conductor layer 11, an insulator layer 12, and the conductor layer 13, the substrate 14, the conductor layer 15, and an electrode pair 16 (see FIG. 3).

The thermal emitter 10 is configured to cause a current to flow in an in-plane direction of the conductor layer 15 in a temperature range near the room temperature (for example, 25° C.) and cause a current to flow in the in-plane direction of the conductor layers 13 and 15 in a temperature range near the operating temperature (for example, 500° C. or 800° C.) by using the drive power supplied from the electrodes 161 and 162 as a pair of electrodes.

The current flowing in the in-plane direction of the conductor layers 13 and 15 generates Joule heat. Therefore, in the thermal emitter module 1, the above-described electromagnetic wave is emitted by heating the thermal emitter 10 to a predetermined operating temperature by using the thermal energy. The operating temperature of the thermal emitter 10 can be appropriately determined within a temperature range in which eutectic reaction in the MIM structure does not proceed. An intensity of light emitted from the thermal emitter 10 increases as the operating temperature increases. In the thermal emitter 10 described in the present embodiment, the operating temperature is assumed to be 300° C. or higher and 1200° C. or lower.

### (Substrate)

The substrate 14 is a semiconductor plate-like member having a pair of principal surfaces 14a and 14b. In the state illustrated in FIG. 3, the principal surface 14a is positioned on the upper side, and the principal surface 14b is positioned on the lower side. A shape of the substrate 14 can be appropriately determined, and is preferably a rectangular shape or a square shape. In the present embodiment, the square shape is adopted as the shape of the substrate 14.

In the present embodiment, silicon, which is an example of a semiconductor and has a resistivity of 1 Ωm, is adopted as a material of the substrate 14. However, it is sufficient if the material of the substrate 14 is a semiconductor whose resistivity decreases with an increase in temperature, and the material of the substrate 14 is not limited to silicon. Furthermore, the resistivity of the semiconductor can be appropriately determined according to the configuration of the thermal emitter 10 (for example, thicknesses of the conductor layer 13, the substrate 14, and the conductor layer 15), the assumed operating temperature, and the like. In the present embodiment, the resistivity of the semiconductor forming the substrate 14 is preferably 1×10⁻² Ωm or more and 2 Ωm or less. In addition, the resistivity of the semiconductor forming the substrate 14 is preferably measured using a resistance measurement method conforming to a standard (such as a standard defined by Japanese Industrial Standards or American Society for Testing and Materials). It is possible to suppress fluctuation in temperature characteristic that may occur in the manufactured thermal emitter 10 by using the semiconductor substrate 14 whose resistivity is guaranteed as described above. A dopant doped in the semiconductor forming the substrate 14 may be either n-type or p-type.

The substrate 14 has a high resistivity at room temperature. In a case of intrinsic silicon as an example of silicon, the resistivity at room temperature is about 1×10³ Ωm. Therefore, when the conductor layer 15 to be described later starts to be energized, no current flows through the substrate 14, and a current flows only through the conductor layer 15.

As described above, the resistivity of the substrate 14 decreases with an increase in temperature. In a case of intrinsic silicon, the resistivity at 300° C. is less than 1×10⁻¹ Ωm, the resistivity at 400° C. is less than 1×10⁻² Ωm, and the resistivity at 500° C. is about 1×10⁻³ Ωm. Therefore, since the resistivity of the substrate 14 decreases as the temperature of the substrate 14 increases, the current flows not only through the conductor layer 15 but also through the conductor layer 13.

As described above, since a parallel current path including the conductor layer 13 and the conductor layer 15 is formed between the electrode 161 and the electrode 162 to be described later, the resistance value between the electrode 161 and the electrode 162 is determined by combining an in-plane resistance value of the conductor layer 13, an in-plane resistance value of the conductor layer 15, and a surface resistance value of the substrate 14 (a resistance value between the conductor layer 13 and the conductor layer 15). In the thermal emitter 10, it is possible to suppress a change in resistance value between the electrode 161 and the electrode 162 at the operating temperature of the thermal emitter 10 by appropriately adjusting the thicknesses of the conductor layer 13, the substrate 14, and the conductor layer 15. Therefore, in the thermal emitter 10, the resistance value between the electrode 161 and the electrode 162 can be adjusted to any resistance value that can be easily monitored.

In addition, in the thermal emitter 10, a temperature of the MIM structure can be grasped by monitoring the resistance value that can occur between the electrode 161 and the electrode 162. Since a spectrum of the electromagnetic wave radiated by the MIM structure depends on the temperature of the MIM structure, in the thermal emitter 10, a predetermined spectrum can be obtained by controlling a current supplied between the electrode pair 16 in such a way that the resistance value that can occur between the electrode 161 and the electrode 162 becomes a predetermined value.

As described above, in the thermal emitter 10, since the resistance value between the electrode 161 and the electrode 162 can be accurately monitored, the temperature of the MIM structure can be easily controlled. In addition, in the thermal emitter 10, since it is not necessary to separately provide a thermometer for monitoring the temperature of the MIM structure, it is possible to reduce the size and cost of the thermal emitter 10.

The thickness of the substrate 14 is preferably 100 μm or more and 1 mm or less. In the present embodiment, the thickness of the substrate 14 is 200 μm.

The MIM structure in which the conductor layer 13, the insulator layer 12, and the conductor layer 11 are stacked in this order is provided on the principal surface 14a. The MIM structure will be described later. On the other hand, the conductor layer 15 and the electrode pair 16 are stacked in this order on the principal surface 14b. The conductor layer 15 and the electrode pair 16 will be described later. The principal surface 14b and the principal surface 14a are examples of a first principal surface and a second principal surface, respectively.

### (Conductor Layer and Electrode Pair)

The conductor layer 15 is provided in such a way as to cover the entire principal surface 14b. The conductor layer 15 functions as a heater that heats the MIM structure and the substrate 14 to be described later by flowing of a current in the in-plane direction by using the electrode pair 16 to be described later. Therefore, a conductor forming the conductor layer 15 preferably has a higher resistivity than copper, aluminum, gold, or the like. In addition, a semiconductor has a characteristic of easily forming eutectic alloys with various metals. For example, tungsten having a melting point of 3422° C. exhibits eutectic reaction with silicon at 650° C. or lower, and the resistivity changes. Therefore, the conductor forming the conductor layer 15 preferably exhibits eutectic reaction with a semiconductor at a high temperature. Preferable examples of the conductor forming the conductor layer 15 include hafnium nitride (HAN), titanium nitride (TiN), and molybdenum (Mo).

The electrodes 161 and 162 included in the electrode pair 16 are provided on a principal surface 15a which is a principal surface (on the lower side in FIG. 3) of the conductor layer 15 that is opposite to the substrate 14.

The electrodes 161 and 162 are provided in an outer edge region of the conductor layer 15 in order to cause a current to flow throughout the conductor layer 15. The outer edge region of the conductor layer 15 is an annular region along four sides forming the conductor layer 15. More specifically, the electrodes 161 and 162 are provided along a pair of opposite sides (a pair of opposite sides positioned on the left side and the right side in FIG. 1A) of the conductor layer 15 having a square shape similarly to the substrate 14. The electrodes 161 and 162 are strip-like or rectangular conductor patterns. The electrode 161 is provided along the side positioned on the left side in FIG. 1A, and the electrode 162 is provided along the side positioned on the right side in FIG. 1A.

In the present embodiment, a three-layer film of Ti/Pt/Au in which titanium (Ti), platinum (Pt), and gold (Au) are stacked in this order on the principal surface 15a is used as the electrodes 161 and 162. A thickness of each layer can be appropriately determined, and in the present embodiment, the thicknesses of Ti and Pt are 30 nm, and the thickness of Au is 500 nm.

By connecting wirings having different polarities to the electrodes 161 and 162, respectively, and supplying power, a current flows from one of the electrodes 161 and 162 to the other. That is, a current flows through the conductor layer 15 in the in-plane direction of the principal surface 15a. Therefore, the electrodes 161 and 162 provided on the principal surface 15a of the conductor layer 15 is an example of electrodes that allow a current to flow in the in-plane direction of the principal surface of the conductor layer 15.

In the present embodiment, as described above, the three-layer film of Ti/Pt/Au, which is an example of a multilayer film, is used as the electrodes 161 and 162. Here, each Ti/Pt layer functions as a base layer, and the Au layer functions as a main conductive layer. The Ti layer as the base layer enhances adhesion of the electrodes 161 and 162 to the conductor layer 15 and reduces a contact resistance that may occur between the conductor layer 15 and the electrodes 161 and 162. In addition, the Pt layer as the base layer prevents or suppresses diffusion that may occur between the Au layer and the Ti layer, and suppresses a change in resistance of the electrode. However, a configuration of the base layer is not limited to Ti/Pt. The configuration of the base layer may be a single-layer film or a multilayer film of three or more layers. In addition, a different metal can be used instead of Au functioning as the main conductor layer, and for example, Ag or an alloy containing Ag as a main component can be used. In addition, in the electrodes 161 and 162, a single-layer film of Au can be adopted without using the base layer of Ti/Pt. The configuration of each of the electrodes 161 and 162 is not limited to the above-described example, and can be appropriately determined in consideration of a high conductivity, a low reactivity, a high melting point, and the like.

In the present embodiment, the electrodes 161 and 162 are provided on the principal surface 15a of the conductor layer 15. This is because the substrate 14 is interposed in a current path through which a current flows in the MIM structure to be described later. However, in a case where the substrate 14 is not interposed in the current path, the electrodes 161 and 162 may be provided on the surface of the conductor layer 13 constituting a part of the MIM structure.

### (MIM Structure)

As illustrated in FIG. 3, the MIM structure included in the thermal emitter 10 includes the conductor layer 11, the insulator layer 12, and the conductor layer 13. The conductor layer 11 is an example of a third conductor layer, and the conductor layer 13 is an example of a second conductor layer. The conductor layer 13, the insulator layer 12, and the conductor layer 11 are stacked in this order on the principal surface 14a of the substrate 14.

The conductor layer 13 is a conductor film formed on the principal surface 14a which is one principal surface (the principal surface on the upper side in FIG. 3) of the substrate 14 in such a way as to cover the entire principal surface 14a. The conductor layer 13 is an example of the second conductor layer.

In the present embodiment, hafnium nitride (HfN) is adopted as a conductor forming the conductor layer 13. However, the conductor forming the conductor layer 13 is not limited to HfN, and may be any material having a metallic conductive characteristic. In a case where the MIM structure is formed on the surface of a base material which is assumed to have a high temperature during use, the conductor layer 13 is preferably made of a material having a high melting point such as HfN. A typical melting point of HfN is 3330° C. In addition, the material of the conductor layer 13 is preferably a material that exhibits eutectic reaction with a semiconductor at a high temperature, such as HfN. HfN exhibits no eutectic reaction with silicon in a temperature range of 1200° C. or lower.

A region of the principal surface 14a where the conductor layer 13 is formed may be the entire principal surface 14a or a part of the principal surface 14a, and can be appropriately determined. In the present embodiment, the conductor layer 13 is formed on the entire principal surface 14a.

In the present embodiment, a thickness of the conductor layer 13 is 140 nm. However, the thickness of the conductor layer 13 is not limited to 140 nm, and can be appropriately determined within a range of, for example, 10 nm or more and 10 μm or less.

The insulator layer 12 is an insulator film formed on a principal surface 13a which is a principal surface (the principal surface on the upper side in FIG. 3) of the conductor layer 13 that is opposite to the substrate 14 in such a way as to cover at least a part of the principal surface 13a. In the present embodiment, as illustrated in FIG. 3, the insulator layer 12 is provided in such a way as to cover the entire principal surface 13a. However, a region of the principal surface 13a where the insulator layer 12 is provided may be the entire principal surface 13a or a part of the principal surface 13a, and can be appropriately determined.

In the present embodiment, the insulator layer 12 which is a solid film having a uniform thickness is formed. However, the insulator layer 12 may be formed only in a region where a plurality of conductor patterns 111 are formed. That is, similarly to the conductor layer 11, the insulator layer 12 may include a plurality of conductor patterns which are periodically arranged and each of which has a circular shape or a regular polygonal shape.

In the present embodiment, SiO₂ is adopted as a material of the insulator layer 12. However, the material of the insulator layer 12 may be any insulator, and is not limited to SiO₂. Examples of such a material include an insulating oxide. In a case where the MIM structure is formed on the principal surface 14a of the substrate 14 that is assumed to have a high temperature during use, the material of the insulator layer 12 is preferably any of SiO₂, aluminum oxide (Al₂O₃), aluminum nitride (AlN), and a mixture of SiO₂ and Al₂O₃.

In the present embodiment, a thickness of the insulator layer 12 is 180 nm. However, the thickness of the insulator layer 12 is not limited to 180 nm, and can be appropriately determined within a range of, for example, 10 nm or more and 10 μm or less.

The conductor layer 11 is formed over the entire principal surface 12a which is a principal surface (the principal surface on the upper side in FIG. 3) of the insulator layer 12 that is opposite to the conductor layer 13. However, a region of the principal surface 12a where the conductor layer 11 is provided may be the entire principal surface 12a or a part of the principal surface 12a, and can be appropriately determined. The conductor layer 11 is an example of the third conductor layer. As described above, the insulator layer 12 and the conductor layer 11 described above are stacked on the principal surface 13a of the conductor layer 13, which is an example of the second conductor layer, in this order.

The conductor layer 11 includes the plurality of (seven in one row in FIG. 3) conductor patterns 111 each having a circular shape. However, the shape of each conductor pattern 111 is not limited to the circular shape, and may be a regular polygonal shape. Preferable examples of the regular polygonal shape include a regular hexagonal shape.

Reference Numeral 111 is given to only one of the plurality of conductor patterns 111. The plurality of conductor patterns 111 are two-dimensionally and periodically arranged on the principal surface 12a. In the present embodiment, square arrangement is adopted as the periodic two-dimensional arrangement of the conductor patterns 111. However, the periodic two-dimensional arrangement is not limited to the square arrangement, and may be, for example, hexagonal arrangement.

In the present embodiment, hafnium nitride (HfN) is adopted as the conductor forming each conductor pattern 111 of the conductor layer 11. However, the conductor forming each conductor pattern 111 is not limited to HfN, and may be any material having a metallic conductive characteristic. In this regard, the conductor forming each conductor pattern 111 is the same as the conductor forming the conductor layer 13.

In the present embodiment, a thickness of the conductor layer 11 (that is, the thickness of each conductor pattern 111) is 40 nm. However, the thickness of the conductor layer 11 is not limited to 40 nm, and can be appropriately determined within a range of, for example, 10 nm or more and 10 μm or less.

As described above in the section describing the support member 30, the resistance values between the pair of electrode patterns of the thermal emitter 10 at 25° C. and 500° C. (the resistance value between the electrode 161 and the electrode 162) are defined as R₁ (Ω) and R_{1H} (Ω), and the resistance value of each of the power supply patterns 41 and 42 at 25° C. is defined as R₂ (Ω). In addition, it is preferable that the resistances R₁, R_{1H}, and R₂ satisfy the following Expressions (1) and (2).

$$2 \times {R}_{2} < {R}_{1} < 10000 \times {R}_{2} \qquad ( 1 )$$

$$2 \times {R}_{2} < {R}_{1 H} < 10000 \times {R}_{2} \qquad ( 2 )$$

Here, the resistance R₁ and the resistance R_{1H} are resistance values of the thermal emitter 10, and mainly depend on design parameters such as the thickness and the material of each of the conductor layer 13, the substrate 14, and the conductor layer 15 described above.

Therefore, by appropriately determining the design parameters of the conductor layer 13, the substrate 14, and the conductor layer 15 that affect the resistance R₁ and the resistance R_{1H} and design parameters in the power supply patterns 41 and 42 that affect the resistance R₂, each resistance value can be set within a range that satisfies Expressions (1) and (2).

### <Another Expression of One Aspect of Present Invention>

In one aspect of the present invention, it is preferable that at least a portion of the support member 30 has a plate-like shape, and a thickness of the plate-like portion is 50 μm or more and 10 mm or more.

As the thickness of the support member 30 decreases, heat conduction from the thermal emitter 10 to the housing 20 is suppressed. However, even in a case where the support member 30 is made of ceramic, the mechanical strength is excessively reduced when the thickness is less than 50 μm. On the other hand, when the thickness of the support member 30 is excessively increased, although the mechanical strength can be easily increased, heat conduction from the thermal emitter 10 to the housing 20 also increases. Therefore, the thickness of the support member 30 is preferably appropriately selected within the above-described range.

The power supply patterns 41 and 42 are preferably thin films made of a metal or alloy and formed on one principal surface of the support member 30. Further, the power supply patterns 41 and 42 may include only the conductive layer, or may include the base layer and the conductive layer. The base layer is a layer for enhancing adhesion of the conductive layer to one principal surface of the support member 30. The thicknesses of the power supply patterns 41 and 42 are preferably 30 nm or more and 10 μm or less.

In a case where the thicknesses of the power supply patterns 41 and 42 exceed 10 μm, an internal stress of the film is likely to increase, so that the power supply patterns 41 and 42 are likely to be peeled off from the support member 30. In a case where the thicknesses of the power supply patterns 41 and 42 are less than 30 nm, Joule heat is likely to be generated due to the resistances of the power supply patterns 41 and 42. Therefore, it is preferable to appropriately select the thicknesses of the power supply patterns 41 and 42 within the above-described range.

In addition, it is preferable that α₁>α₂, where α₁ is a linear expansion coefficient of the material of the housing 20, and α₂ is a linear expansion coefficient of the material of the support member 30.

In the thermal emitter module 1, when the temperature of the thermal emitter 10 has reached the operating temperature, the support member 30 positioned near the thermal emitter 10 also has a higher temperature than the housing 20 positioned far from the thermal emitter 10. Therefore, a difference between a linear expansion amount in the support member 30 and a linear expansion amount in the housing 20 can be reduced by appropriately selecting the linear expansion coefficients α₁ and α₂ within the above-described ranges.

In addition, the emissivity of the thermal emitter 10 at 500° C. is preferably 0.5 or more and 1.0 or less in at least a part of a wavelength band of 500 nm or more and 10 μm or less.

For example, the thermal emitter 10 illustrated in FIG. 3 has an emissivity of 0.9 in a wavelength band of 1000 nm or more and 2000 nm or less. The emissivity of such a thermal emitter 10 can exceed the emissivity (0.43) of tungsten that is hitherto often used as a filament.

In addition, a temperature of at least a part of the thermal emitter 10, which is a temperature at the time of driving the thermal emitter 10, is preferably 500° C. or higher and 2000° C. or lower. That is, the operating temperature of the thermal emitter 10 is preferably 500° C. or higher and 2000° C. or lower.

With the thermal emitter module 1, a difference between the operating temperature of the thermal emitter 10 and the temperature of the surface of the housing 20 can be increased. Therefore, the higher the operating temperature of the thermal emitter 10, the more easily the thermal emitter module 1 exerts its effect. Therefore, in the thermal emitter module 1, the operating temperature of the thermal emitter 10 is preferably within the above-described range.

### Supplementary Note

The present invention is not limited to the above-described embodiments, but can be modified in various ways within the scope of the claims. Embodiments obtained by appropriately combining technical means disclosed in different embodiments are also included in the technical scope of the present invention.

### Example 1

Hereinafter, Example 1 of the present invention will be described. Example 1 is an example of the thermal emitter module 1 illustrated in FIGS. 1A and 1B. In the present example, the following configuration is adopted in the thermal emitter module 1.
Thermal emitter 10 (see FIG. 3): R₁=10Ω and R_{1H}=5Ω
Housing 20: Ceramic package (KD-S92459 manufactured by KYOCERA Corporation)
Optical window 23 of housing 20: Glass (BDA-E manufactured by Nippon Electric Glass Co., Ltd.)
Bonding of frame body 22 and optical window 23: Gold-tin solder preform
Pressure inside cavity C: 1 Pa
Support member 30: Adceram-CS (registered trademark) D3 with thickness of 0.3 mm
Power supply patterns 41 and 42: R₂=0.6Ω, bilayer film of titanium/platinum as base layer, and gold film with thickness of 500 nm as conductive layer
MAX302 manufactured by NIHON HANDA Inc., which is a sintered silver paste, was used for each of the bonding between the electrodes 161 and 162 and the power supply patterns 41 and 42 and the bonding between the power supply patterns 41 and 42 and the power terminals 25 and 26.

When the operating temperature of the thermal emitter 10 was maintained at 500° C. by supplying the drive power to the power terminals 25 and 26, the temperature of the surface of the housing 20 was 85° C. in a state of not using forced cooling means such as a fan. As a result, it was found that in Example 1, the temperature of the surface of the housing 20 can be suppressed.

### Example 2

Hereinafter, Example 2 of the present invention will be described. Example 2 is an example in which the support member 30a (see FIG. 2B) is adopted instead of the support member 30 (see FIG. 2A) in the thermal emitter module 1 illustrated in FIGS. 1A and 1B. A configuration different from that of Example 1 will be described below.
Power supply patterns 41a and 42a: R₂=0.2Ω, bilayer film of titanium/platinum as base layer, and APC-TR (registered trademark) film with thickness of 5000 nm as conductive layer
APC-TR (registered trademark) is an alloy of lead and copper containing silver as a main component.

When the operating temperature of the thermal emitter 10 was maintained at 500° C., the temperature of the surface of the housing 20 was 40° C. in a state of not using forced cooling means such as a fan. As a result, it was found that in Example 2, the temperature of the surface of the housing 20 can be suppressed.

### Example 3

Hereinafter, Example 3 of the present invention will be described. Example 3 is an example in which the support member 30b (see FIG. 2C) is adopted instead of the support member 30 (see FIG. 2A) in the thermal emitter module 1 illustrated in FIGS. 1A and 1B. A configuration different from that of Example 1 will be described below.
Optical window 23 of housing 20: Glass (TEMPAX Float (registered trademark) manufactured by Schott AG)
Thermal emitter 10 (see FIG. 3): Carbon film formed on substrate, R₁=6Ω and R_{1H}=8Ω
Support member 30b: CeraFlex A (registered trademark) with thickness of 0.32 mm
Power supply patterns 41 and 42: R₂=2Ω, bilayer film of titanium/platinum as base layer, and gold film with thickness of 200 nm as conductive layer

When the operating temperature of the thermal emitter 10 was maintained at 500° C. by supplying the drive power to the power terminals 25 and 26, the temperature of the surface of the housing 20 was 125° C. in a state of not using forced cooling means such as a fan. As a result, it was found that in Example 3, the temperature of the surface of the housing 20 can be suppressed.

### Example 4

Hereinafter, Example 4 of the present invention will be described. Example 4 is an example in which the support member 30c (see FIG. 2D) is adopted instead of the support member 30 (see FIG. 2A) in the thermal emitter module 1 illustrated in FIGS. 1A and 1B. A configuration different from that of Example 1 will be described below.
Optical window 23 of housing 20: Glass (TEMPAX Float (registered trademark) manufactured by Schott AG)
Thermal emitter 10 (see FIG. 3): Silicon substrate whose surface is roughened, R₁=20Ω and R_{1H}=10Ω
Support member 30c: Quartz glass with thickness of 0.28 mm

When the operating temperature of the thermal emitter 10 was maintained at 500° C. by supplying the drive power to the power terminals 25 and 26, the temperature of the surface of the housing 20 was 150° C. in a state of not using forced cooling means such as a fan. As a result, it was found that in Example 4, the temperature of the surface of the housing 20 can be suppressed.

### Example 5

Hereinafter, Example 5 of the present invention will be described. Example 5 is an example in which the support member 30d (see FIG. 2E) is adopted instead of the support member 30 (see FIG. 2A) in the thermal emitter module 1 illustrated in FIGS. 1A and 1B. A configuration different from that of Example 1 will be described below.
Thermal emitter 10 (see FIG. 3): Silicon substrate whose surface is roughened, R₁=20Ω and R_{1H}=10Ω
Support member 30d: Quartz glass with thickness of 0.28 mm

A gold wire was used for each of bonding of the pair of electrodes of the thermal emitter 10 and the power supply patterns of the support member 30 and bonding of the power supply patterns and the power terminals 25 and 26. The gold wire was bonded by a wire bonding method.

When the operating temperature of the thermal emitter 10 was maintained at 500° C. by supplying the drive power to the power terminals 25 and 26, the temperature of the surface of the housing 20 was 110° C. in a state of not using forced cooling means such as a fan. As a result, it was found that in Example 4, the temperature of the surface of the housing 20 can be suppressed.

### Comparative Example

A comparative example of the present invention will be described below. In the comparative example, the support member (for example, the support member 30) included in one aspect of the present invention is not provided, and the electrodes 161 and 162 of the thermal emitter 10 are directly fixed to the power terminals 25 and 26 of the housing 20. A configuration different from that of Example 1 will be described below.
Housing 20: Ceramic package (KD-S89702 manufactured by KYOCERA Corporation)
MAX302 manufactured by NIHON HANDA Inc., which is a sintered silver paste, was used for the bonding between the electrodes 161 and 162 and the power terminals 25 and 26.

When the operating temperature of the thermal emitter 10 was maintained at 500° C. by supplying the drive power to the power terminals 25 and 26, the temperature of the surface of the housing 20 was 280° C. in a state of not using forced cooling means such as a fan.

In the comparative example, the thermal emitter 10 is directly fixed to the housing 20 without interposing the support member 30 between the thermal emitter 10 and the housing 20. Therefore, the comparative example corresponds to the thermal emitter module described in JP 2020-98757 A.

What is claimed is:

1. A thermal emitter module comprising:
a thermal emitter;
a housing configured to house the thermal emitter; and
a support member interposed between the thermal emitter and the housing and configured to support the thermal emitter,
wherein a constituent material of the support member contains at least one of an oxide or a nitride.

2. The thermal emitter module according to claim 1, wherein
the housing has a cavity that houses the thermal emitter and the support member,
the support member has a first region that is provided in a region including a center of gravity and in which the thermal emitter is installed, and a second region that is provided in a region separated from the first region and in which the support member is fixed to the housing, and
a region of the support member including the first region other than the second region is separated from an inner wall of the cavity.

3. The thermal emitter module according to claim 2, wherein
the support member further has a third region interposed between the first region and the second region, and
a width of the third region is smaller than a width of the thermal emitter in at least a part of an entire section extending between the first region and the second region.

4. The thermal emitter module according to claim 3, wherein
the support member is a plate-like member in which the first region, the second region, and the third region extend along one plane.

5. The thermal emitter module according to claim 4, wherein
the support member has a pair of principal surfaces facing each other,
the first region is provided on one principal surface of the support member,
a pair of power supply patterns extending from the second region to the first region via the third region is provided on the one principal surface, the pair of power supply patterns being made of metal films, and
each of the pair of power supply patterns is electrically connected to each of a pair of electrode patterns included in the thermal emitter in the first region.

6. The thermal emitter module according to claim 5, wherein
$$2 \times {R}_{2} < {R}_{1} < 10000 \times {R}_{2} \qquad ( 1 )$$
$$2 \times {R}_{2} < {R}_{1 H} < 10000 \times {R}_{2} \qquad ( 2 )$$
where
R₁ (Ω) and R_{1H} (Ω) are resistance values between the pair of electrode patterns at 25° C. and 500° C., and
R₂ (Ω) is a resistance value of each of the pair of power supply patterns at 25° C.

7. The thermal emitter module according to claim 5, wherein
the pair of power supply patterns is any of gold, silver, and an alloy containing silver as a main component.

8. The thermal emitter module according to claim 1, wherein
a thermal conductivity of the constituent material is 0.1 W/m·° C. or more and 30 W/m·° C. or less.

9. The thermal emitter module according to claim 2, wherein the constituent material is a ceramic material, and the cavity has an internal pressure lower than an atmospheric pressure and is sealed.

10. The thermal emitter module according to claim 9, wherein
the ceramic material is a mixture of calcium silicate and lithium aluminosilicate.

11. A thermal radiation light source comprising:
the thermal emitter module according to claim 1.
